(19) United States
(12) Patent Application Publication
(10) Pub. No.: US 2024/0354142 A1
(43) Pub. Date: Oct. 24, 2024

(54) METHOD AND SYSTEM FOR LOAD BALANCING IN SUSTAINABLE ENERGY ENVIRONMENTS

(71) Applicant: Dell Products L.P., Round Rock, TX (US)

(72) Inventors: Parminder Singh Sethi, Ludhiana (IN); Lakshmi Saroja Nalam, Bangalore (IN)

(21) Appl. No.: 18/304,069

(22) Filed: Apr. 20, 2023

(51) Int. Cl. G06F 9/455

(52) U.S. Cl. CPC G06F 9/45558; G06F 2009/4557; G06F 2009/45595

(57) ABSTRACT

A method for load balancing of application instances between multiple data centers includes performing a first forecast of sustainable energy information for each of the data centers, where a first data center is forecasted to be provided with a greater share of sustainable energy than a second data center. The method also includes performing a second forecast of system resource utilization and associated power needs for an application and instantiating, based on the first and second forecasts, first application instances of the application in the first data center and second application instances of the application in the second data center. Further, the method includes making a determination that one of the first application instances includes sufficient resources to service an incoming request, and routing, based on the determination, an incoming request to one of the first application instances.

### BACKGROUND

Computing devices may provide services. To provide the services, the computing devices may include hardware components and software components. The software components may store information usable to provide the services using the hardware components. Further, hardware components may be distributed across different locations and the electrical power provided to the hardware components may have different carbon footprints.

### SUMMARY

In general, embodiments described herein relate to a method for load balancing of application instances between multiple data centers. The method includes performing a first forecast of sustainable energy information for each of the data centers, where a first data center is forecasted to be provided with a greater share of sustainable energy than a second data center. The method also includes performing a second forecast of system resource utilization and associated power needs for an application and instantiating, based on the first and second forecasts, first application instances of the application in the first data center and second application instances of the application in the second data center. Further, the method includes making a determination that one of the first application instances includes sufficient resources to service an incoming request, and routing, based on the determination, an incoming request to one of the first application instances.

In general, embodiments described herein relate to a method for load balancing of application instances between multiple data centers. The method includes performing a first forecast of sustainable energy information for each of the data centers, where a first data center is forecasted to be provided with a greater share of sustainable energy than a second data center. The method also includes performing a second forecast of system resource utilization and associated power needs for an application, and instantiating, based on the first and second forecasts, first application instances of the application in the first data center and second application instances of the application in the second data center.

In general, embodiments described herein relate to a non-transitory computer readable medium comprising computer readable program code. The computer readable code, which when executed by a computer processor, enables the computer processor to perform a method for load balancing of application instances between multiple data centers. The method includes performing a first forecast of sustainable energy information for each of the data centers, where a first data center is forecasted to be provided with a greater share of sustainable energy than a second data center. The method also includes performing a second forecast of system resource utilization and associated power needs for an application, and instantiating, based on the first and second forecasts, first application instances of the application in the first data center and second application instances of the application in the second data center.

Other aspects of the embodiments disclosed herein will be apparent from the following description and the appended claims.

### BRIEF DESCRIPTION OF DRAWINGS

Certain embodiments of the invention will be described with reference to the accompanying drawings. However, the accompanying drawings illustrate only certain aspects or implementations of the invention by way of example, and are not meant to limit the scope of the claims.

FIG. 1 shows a diagram of a system in accordance with one or more embodiments.

FIG. 2 shows a method for load balancing of application instances in accordance with one or more embodiments.

FIG. 3 shows a diagram of a system in accordance with one or more embodiments.

FIG. 4 shows a diagram of a computing device in accordance with one or more embodiments.

### DETAILED DESCRIPTION

In the below description, numerous details are set forth as examples of embodiments described herein. It will be understood by those skilled in the art, and having the benefit of this Detailed Description, that one or more embodiments described herein may be practiced without these specific details and that numerous variations or modifications may be possible without departing from the scope of the embodiments described herein. Certain details known to those of ordinary skill in the art may be omitted to avoid obscuring the description.

In the following description of the figures, any component described with regard to a figure, in various embodiments of the invention, may be equivalent to one or more like-named components described with regard to any other figure. For brevity, descriptions of these components will not be repeated with regard to each figure. Thus, each and every embodiment of the components of each figure is incorporated by reference and assumed to be optionally present within every other figure having one or more like-named components. Additionally, in accordance with various embodiments of the invention, any description of the components of a figure is to be interpreted as an optional embodiment, which may be implemented in addition to, in conjunction with, or in place of the embodiments described with regard to a corresponding like-named component in any other figure.

Throughout this application, elements of figures may be labeled as A to N. As used herein, the aforementioned labeling means that the element may include any number of items, and does not require that the element include the same number of elements as any other item labeled as A to N. For example, a data structure may include a first element labeled as A and a second element labeled as N. This labeling convention means that the data structure may include any number of the elements. A second data structure, also labeled as A to N, may also include any number of elements. The number of elements of the first data structure, and the number of elements of the second data structure, may be the same or different.

Throughout the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as by the use of the terms “before”, “after”, “single”, and other such terminology. Rather, the use of ordinal numbers is to distinguish between the elements. By way of an example, a first element is distinct from a second element, and the first element may encompass more than one element and succeed (or precede) the second element in an ordering of elements.

As used herein, the phrase operatively connected, or operative connection, means that there exists between elements/components/devices a direct or indirect connection that allows the elements to interact with one another in some way. For example, the phrase ‘operatively connected’ may refer to any direct connection (e.g., wired directly between two devices or components) or indirect connection (e.g., wired and/or wireless connections between any number of devices or components connecting the operatively connected devices). Thus, any path through which information may travel may be considered an operative connection.

In general, embodiments described herein relate to methods, systems and non-transitory computer readable mediums storing instructions for creating and executing load balancing operations between data centers. In one or more embodiments, load balancing operations include minimizing the carbon footprint of data center operations without affecting a user experience.

In one or more embodiments, a load balancer agent may be included to execute load balancing operations between data centers. The load balancer agent instantiates application instances in data centers based on the predicted amount of sustainable energy used by each data center. In doing so, in one or more embodiments, the load balancer agent is provided with information regarding each data center's environment, the amount and type (e.g., wind, solar, gas turbine, coal fire, etc.) of energy production available to each data center, and which data centers are configured to utilize sustainable energy. Further, the load balancer agent may also have functionality to (i) forecast the weather and/or sustainable energy type (ii) forecast system resource utilization and associated power needs for each application instance, (iii) set threshold values for system resource utilization needs for each application instance based on the forecasts, (iv) instantiate application instances, and (v) route incoming requests to the different application instances to maximize the use of sustainable energy and minimize the carbon footprint associated with processing the incoming requests.

The following describes various embodiments of the invention.

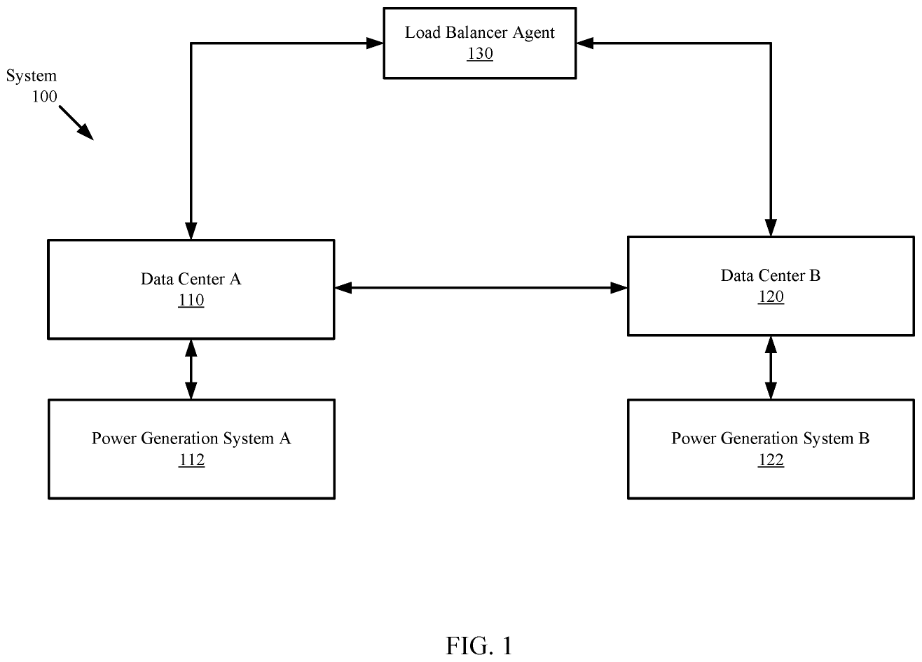

FIG. 1 shows a diagram of a system (100) in accordance with one or more embodiments. The system (100) includes one or more data centers (e.g., Data Center A (110), Data Center B (120), etc.), two or more power generation systems (e.g., Power Generation System A (112), Power Generation System B (122), etc.), and a load balancer agent (130). The system (100) may include additional, fewer, and/or different components without departing from the scope of the embodiments disclosed herein. Each component may be operably connected to any of the other components via any combination of wired and/or wireless connections. Further, the power generation systems may be electrically connected to any of the other components via any electrical power generation and/or transmission infrastructure. Each component illustrated in FIG. 1 is discussed below.

In one or more embodiments, the data centers (110, 120) and the load balancer agent (130) may be physical or logical devices, as discussed below. Data Center A (110) may be operably connected to Data Center B (120) via a network (not shown), in which the network may allow Data Center A (110) (e.g., components of Data Center A (110)) to communicate with Data Center B (120) (e.g., components of Data Center B (120)). Further, Data Center A (110) and Data Center B (120) may be directly connected, without an intervening network. In addition, Data Center A (110) and Data Center B (120) may include any further number of data centers that each receive power for different power generation systems. For example, a third data center may receive power from a third power generation system.

Further, the functioning of Data Center A (110) and Data Center B (120) is not dependent upon the functioning and/or existence of the other components (e.g., devices) in the system (100). Rather, Data Center A (110) and Data Center B (120) may function independently and perform operations locally that do not require communication with other components. Accordingly, embodiments disclosed herein should not be limited to the configuration of components shown in FIG. 1.

As used herein, “communication” may refer to simple data passing, or may refer to two or more components coordinating a job.

As used herein, the term “data” is intended to be broad in scope. In this manner, that term embraces, for example (but not limited to): data segments that are produced by data stream segmentation processes, data chunks, data blocks, atomic data, emails, objects of any type, files of any type (e.g., media files, spreadsheet files, database files, etc.), contacts, directories, sub-directories, volumes, etc.

In one or more embodiments, although terms such as “document”, “file”, “segment”, “block”, or “object” may be used by way of example, the principles of the disclosure are not limited to any particular form of representing and storing data or other information. Rather, such principles are equally applicable to any object capable of representing information.

In one or more embodiments, the system also includes the load balancer agent (130). In one or more embodiments, the load balancer agent (130) is operatively connected to each of the data centers (e.g., 110, 120). The load balancer agent (130) may be located within any one of the data centers, at each data center, at a portion of the data center, or separate from and connected to each data center.

In one or more embodiments, a computing device is any device, portion of a device, or any set of devices capable of electronically processing instructions and may include, but is not limited to, any of the following: one or more processors (e.g. components that include integrated circuitry) (not shown), memory (e.g., random access memory (RAM)) (not shown), input and output device(s) (not shown), non-volatile storage hardware (e.g., solid-state drives (SSDs), hard disk drives (HDDs) (not shown)), one or more physical interfaces (e.g., network ports, storage ports) (not shown), any number of other hardware components (not shown) and/or any combination thereof.

Examples of computing devices include, but are not limited to, a server (e.g., a blade-server in a blade-server chassis, a rack server in a rack, etc.), a desktop computer, a mobile device (e.g., laptop computer, smart phone, personal digital assistant, tablet computer and/or any other mobile computing device), a storage device (e.g., a disk drive array, a fiber channel storage device, an Internet Small Computer Systems Interface (iSCSI) storage device, a tape storage device, a flash storage array, a network attached storage device, etc.), a network device (e.g., switch, router, multi-layer switch, etc.), a virtual machine, a virtualized computing environment, a logical container (e.g., for one or more applications), and/or any other type of computing device with the aforementioned requirements. In one or more embodiments, any or all of the aforementioned examples may be combined to create a system of such devices, which may collectively be referred to as a computing device. Other types of computing devices may be used without departing from the scope of the invention. In one or more embodiments, a set of computing devices may form all or a portion of a data domain, all, or part of which may require migrating from time to time (e.g., upon request and/or pursuant to a defined schedule). In one or more embodiments, a data domain is any set of computing devices for which data migration operations are performed.

In one or more embodiments, the non-volatile storage (not shown) and/or memory (not shown) of a computing device or system of computing devices may be one or more data repositories for storing any number of data structures storing any amount of data (i.e., information). In one or more embodiments, a data repository is any type of storage unit and/or device (e.g., a file system, database, collection of tables, RAM, and/or any other storage mechanism or medium) for storing data. Further, the data repository may include multiple different storage units and/or devices. The multiple different storage units and/or devices may or may not be of the same type or located at the same physical location.

In one or more embodiments, a computing device includes and/or is operatively connected to any number of storage volumes (not shown). In one or more embodiments, a volume is a logically accessible storage element of a computing system. A volume may be part of one or more disk drives, and may or may not include any number of partitions. In one or more embodiments, a volume stores information relevant to the operation and/or accessible data of a computing device. In one or more embodiments, a volume may be all or part of any type of computing device storage (described above).

In one or more embodiments, any non-volatile storage (not shown) and/or memory (not shown) of a computing device or system of computing devices may be considered, in whole or in part, as non-transitory computer readable mediums storing software and/or firmware.

Such software and/or firmware may include instructions which, when executed by the one or more processors (not shown) or other hardware (e.g., circuitry) of a computing device and/or system of computing devices, cause the one or more processors and/or other hardware components to perform operations in accordance with one or more embodiments described herein.

The software instructions may be in the form of computer readable program code to perform methods of embodiments as described herein, and may, as an example, be stored, in whole or in part, temporarily or permanently, on a non-transitory computer readable medium such as a compact disc (CD), digital versatile disc (DVD), storage device, diskette, tape storage, flash storage, physical memory, or any other non-transitory computer readable medium.

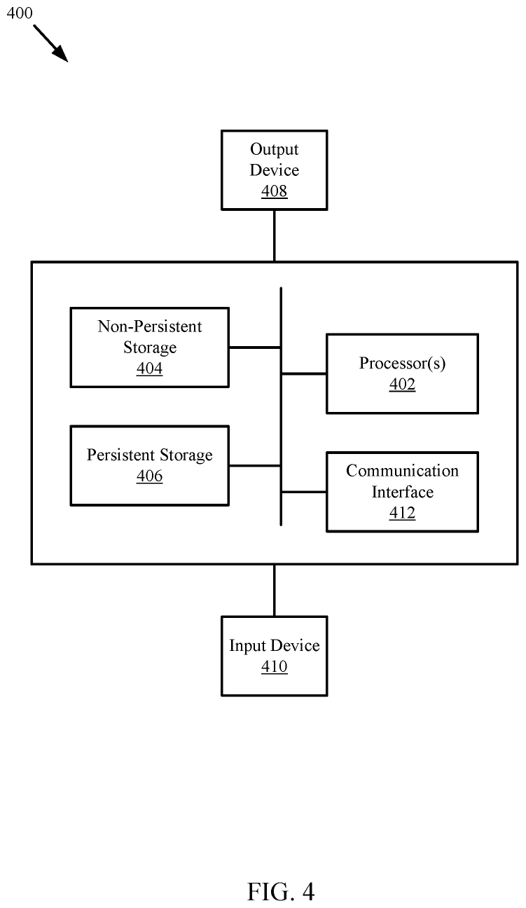

In one or more embodiments, the system (100) may deliver computing power, storage capacity, and data protection (e.g., software-defined data protection) as a service to users of the client device(s) (Not shown). The system (100) may also represent a comprehensive middleware layer executing on computing devices (e.g., 400, FIG. 4) that supports virtualized application environments. In one or more embodiments, the system (100) may support one or more virtual machine (VM) environments, and may map capacity requirements (e.g., computational load, storage access, etc.) of VMs and supported applications to available resources (e.g., processing resources, storage resources, etc.) managed by the environments. Further, the system (100) may be configured for workload placement collaboration and computing resource (e.g., processing, storage/memory, virtualization, networking, etc.) exchange.

As used herein, “computing” refers to any operations that may be performed by a computer, including (but not limited to): computation, data storage, data retrieval, communications, etc.

As used herein, a “computing device” refers to any device in which a computing operation may be carried out. A computing device may be, for example (but not limited to): a compute component, a storage component, a network device, a telecommunications component, etc.

As used herein, a “resource” refers to any program, application, document, file, asset, executable program file, desktop environment, computing environment, or other resource made available to, for example, a user of a client (described below). The resource may be delivered to the client via, for example (but not limited to): conventional installation, a method for streaming, a VM executing on a remote computing device, execution from a removable storage device connected to the client (such as universal serial bus (USB) device), etc.

In one or more embodiments, as being a physical computing device or a logical computing device (e.g., a VM), a data center (e.g., 110, 120, etc.) may be configured for hosting and maintaining various workloads, and/or for providing a computing environment (e.g., computing power and storage) whereon workloads may be implemented. In general, a data center's (e.g., a site's, a node's, etc.) infrastructure is based on a network of computing and storage resources that enable the delivery of shared applications and data. For example, a data center (e.g., 110) of an organization may exchange data with other data centers (e.g., 120) of the same organization registered in/to a network in order to, for example, participate in a collaborative workload placement. As yet another example, a data center (e.g., 110) may split up a request (e.g., an operation, a task, an activity, etc.) with another data center (e.g., 120), coordinating its efforts to complete the request (e.g., to generate a response) more efficiently than if the data center (e.g., 110) had been responsible for completing the request. One of ordinary skill will appreciate that a data center (e.g., 110, 120, etc.) may perform other functionalities without departing from the scope of the invention.

In one or more embodiments, a data center (e.g., 110, 120, etc.) may be capable of providing the aforementioned functionalities/services to the user of the clients. However, not all of the users may be allowed to receive all of the services. For example, the priority (e.g., the user access level) of a user may be used to determine how to manage computing resources within a data center (e.g., 110, 120, etc.) to provide services to that user. As yet another example, the priority of a user may be used to identify the services that need to be provide to that user. As yet another example, the priority of a user may be used to determine how quickly communications (for the purposes of providing services in cooperation with the network (and its subcomponents)) are to be processed by the network.

In one or more embodiments, a data center (e.g., 110, 120, etc.) may include, for example (but not limited to): a router, a switch, a firewall, a security module, a storage infrastructure, a server, an application-delivery controller, a network device, etc. A data center (e.g., 110, 120, etc.) may support business application and activities (e.g., actions, behaviors, etc.) that include, for example (but not limited to): email and asset (e.g., a file, a folder, etc.) sharing, one or more production workloads, customer relationship management, enterprise resource planning, artificial intelligence (AI)/machine learning (ML)-based activities, virtual desktop infrastructure (VDI) environments, collaboration services, etc.

In one or more embodiments, the components (described above) of a data center (e.g., 110, 120, etc.) provide, at least, (i) network infrastructure (which connects servers (physical and/or virtualized), data center services, storage, and external connectivity to end-user locations (e.g., clients)), (ii) storage infrastructure, and (iii) computing resources (e.g., processing, memory, local storage, network connectivity, etc.) that drive applications.

As used herein, a “workload” is a physical or logical component configured to perform certain work functions. Workloads may be instantiated and operated while consuming computing resources allocated thereto. A user may configure a data protection policy for various workload types. Examples of a workload may include (but not limited to): a data protection workload, a VM, a container, a network-attached storage (NAS), a database, an application, a collection of micro services, a file system (FS), small workloads with lower priority workloads (e.g., FS host data, operating system (OS) data, etc.), medium workloads with higher priority (e.g., VM with FS data, network data management protocol (NDMP) data, etc.), large workloads with critical priority (e.g., mission critical application data), etc.

As used herein, a “policy” is a collection of information, such as a backup policy or other data protection policy, that includes, for example (but not limited to): identity of source data that is to be protected, backup schedule and retention requirements for backed up source data, identity of a service level agreement (SLA) (or a rule) that applies to source data, identity of a target device where source data is to be stored, etc.

As used herein, a “rule” is a guideline used by an SLA component to select a particular target device (or target devices), based on the ability of the target device to meet requirements imposed by the SLA. For example, a rule may specify that a hard disk drive (HDD) having a particular performance parameter should be used as the target device. A target device selected by the SLA component may be identified as part of a backup policy or other data protection policy.

As used herein, an “SLA” between, for example, a vendor and a user may specify one or more user performance requirements (that define, for example, a target device to be chosen dynamically during, and as part of, a data protection process), for example (but not limited to): how many copies should be made of source data, latency requirements, data availability requirements, recovery point objective (RPO) requirements, recovery time objective (RTO) requirements, etc. In most cases, the user may be agnostic as to which particular target devices are used, as long as the user performance requirements are satisfied.

In one or more embodiments, data protection policies used to protect massive amounts of data may require a certain level of intelligence to infer (e.g., to determine) SLAs of a user and provide ease of implementing data protection by reducing manual effort as much as possible to meet user expectations (or user demands). Further, a data protection policy may be defined and implemented to determine target device(s) that are best suited to meet user SLAs (that are defined within the policy). In some cases, user SLAs may be assigned to particular data protection policies for different types of data protection workloads.

As used herein, a “server” may be a physical computing device or a logical computing device (e.g., a VM) and may include functionality to: (i) provide computer-implemented services (e.g., receiving a request, sending a response to the request, etc.) to one or more entities (e.g., users, components of the system (100), etc.) and (ii) exchange data with other components registered in/to the network in order to, for example, participate in a collaborative workload placement.

For example, a server may split up a request with another component of the system (e.g., 100, FIG. 1), coordinating its efforts to complete the request (e.g., to generate a response) more efficiently than if the server had been responsible for completing the request. In one or more embodiments, a request may be, for example (but not limited to): a web browser search request, a representational state transfer (REST) request, a computing request, a database management request, etc. To provide the computer-implemented services to the entities, the server (e.g., an enterprise server, a modular server, a blade server, a mainframe, a workstation computer, etc.) may perform computations locally and/or remotely. By doing so, the server may utilize different computing devices (e.g., 400, FIG. 4) that have different quantities of computing resources (e.g., processing cycles, memory, storage, etc.) to provide a consistent experience to the entities. In one or more embodiments, the server may be a heterogeneous set, including different types of hardware components and/or different types of OSs.

As used herein, a “container” is an executable unit of software in which an application code is packaged, along with its libraries and dependencies, so that it can be executed anywhere. To do this, a container takes advantage of a form of OS virtualization in which features of the OS are leveraged to both isolate processes and control the amount of central processing unit (CPU), memory, and disk that those processes have access to.

Comparing to a VM, a container does not need to include a guest OS in every instance and may simply leverage the features and resources of a host OS. For example, instead of virtualizing the underlying hardware components, a container virtualize the OS, so the container includes only the application (and its libraries and dependencies). The absence of the guest OS makes a container lightweight, fast, and portable.

Further, comparing to a conventional data center scenario, in which (i) all the necessary hardware and software components are needed to be acquired and (ii) an entire infrastructure team is needed to build and configure all aspects of the infrastructure (which may take weeks), the above process may take only minutes with containers. Containers may also include functionality to: (i) perform disaster recovery (with this functionality, even if multiple containers fail, applications may continue to execute uninterrupted), (ii) perform seamless auto-scaling up and down (e.g., via instruction from the load balancer agent (130)) with little to no intervention on the part of a user (with this functionality, as demand grows, containers may eliminate the need to add more servers or allocate more resources in a costly way), and (iii) reduce labor-intensive efforts and costs, in which containers may require very few personnel to manage and monitor applications and instances. One of ordinary skill will appreciate that containers may perform other functionalities without departing from the scope of the invention.

As used herein, a “file system” is a method that an OS (e.g., Microsoft® Windows, Apple® MacOS, etc.) uses to control how data is named, stored, and retrieved. For example, once a user has logged into a computing device (e.g., 400, FIG. 4), the OS of that computing device uses the file system (e.g., new technology file system (NTFS), a resilient file system (ReFS), a third extended file system (ext3), etc.) of that computing device to retrieve one or more applications to start performing one or more operations (e.g., functions, tasks, activities, jobs, etc.). As yet another example, a file system may divide a volume (e.g., a logical drive) into a fixed group of bytes to generate one or more blocks of the volume.

As used herein, a “cloud” refers to servers that are accessed over the Internet (and the software and databases that executes on those servers). With the help of cloud (or “cloud computing”), users or organizations do not need to manage physical servers themselves or execute software applications on their own computing devices. In most cases, a cloud enables users to access same files and/or applications from almost any computing device, because the computing and storage take place on servers, instead of locally on users' computing devices. For example, a user may log into the user's email account on a new computing device and still may find the email account in place with all email conversion history.

Cloud computing is possible because of a technology called “virtualization”. Virtualization allows for the generation of a VM that behaves as if it was a physical computing device with its own hardware components. When properly implemented, VMs on the same host are sandboxed from one another so that they do not interact with each other, and the files and/or applications from one VM are not visible to another VM even though they are on the same physical computing device.

In one or more embodiments, cloud computing environments (which may or may not be public) may include storage environments that may provide data protection functionality for one or more users. Cloud computing environments may also perform computer-implemented services (e.g., data protection, data processing, etc.) on behalf of one or more users. Some example cloud computing environments that embodiments of the invention may be employed include (but not limited to): Microsoft® Azure, Amazon® AWS, Dell® Cloud Storage Services, Google® Cloud, etc.

In one or more embodiments, a data center (e.g., 110, 120, etc.) may be a part of a business operation region (BOR) (not shown) of an organization, in which the BOR corresponds to a geographic region (e.g., a city, a county, a state, a province, a country, a country grouping (e.g., the European Union), etc.). For example, Data Center A (110) of Organization X may be located in the United States and Data Center B (120) of Organization X may be located in the Netherlands, in which Organization X has multiple geographically distributed data centers around the world.

In one architecture (e.g., the “unidirectional” architecture), one of the data centers (e.g., the parent data center) of an organization may be deployed to the United States, which serves (e.g., shares) data to/among the remaining data centers (e.g., the child data centers that are deployed to Argentina, India, and France) of the organization. In this architecture, the child data centers may transmit their data to the parent data center so that the parent data center is always updated. Thereafter, the parent data center may distribute/forward received data to the child data centers to keep the child data centers equally updated.

In another architecture (e.g., the “bidirectional” architecture), one of the data centers of an organization may be deployed to Greece and the other one may be deployed to Spain, in which both data centers know each other and when a data change is occurred in one of them, the other data center may automatically obtain that data to stay updated. Further, in another architecture (e.g., the “multidirectional” architecture), an organization may have multiple data centers deployed around the world and all of the data centers know each other. When one of the data centers is updated (e.g., when that data centers receives a software package), the remaining data centers are updated accordingly (e.g., by sending a data transfer request to each of the remaining data centers).

In one or more embodiments, the data center (e.g., 110, 120, etc.) and/or the load balancer agent (130) may be implemented as a computing device (e.g., 400, FIG. 4). The computing device may be, for example, a mobile phone, a tablet computer, a laptop computer, a desktop computer, a server, a distributed computing system, or a cloud resource. The computing device may include one or more processors, memory (e.g., random access memory (RAM)), and persistent storage (e.g., disk drives, solid-state drives (SSDs), etc.). The computing device may include instructions, stored in the persistent storage, that when executed by the processor(s) of the computing device cause the computing device to perform the functionality of the data center described throughout this application.

Alternatively, in one or more embodiments, the data center (e.g., 110, 120, etc.) and/or the load balancer agent (130) may be implemented as a logical device. The logical device may utilize the computing resources of any number of computing devices to provide the functionality of the data center (e.g., 110, 120, etc.) and/or the load balancer agent (130) described throughout this application.

In one or more embodiments, a processing resource (not shown) may refer to a measurable quantity of a processing-relevant resource type, which can be requested, allocated, and consumed. A processing-relevant resource type may encompass a physical device (i.e., hardware), a logical intelligence (i.e., software), or a combination thereof, which may provide processing or computing functionality and/or services. Examples of a processing-relevant resource type may include (but not limited to): a CPU, a graphical processing unit (GPU), a data processing unit (DPU), a computation acceleration resource, application specific integrated circuits (ASICs), a digital signal processor for facilitating high speed communication, etc.

In one or more embodiments, a storage or memory resource (not shown) may refer to a measurable quantity of a storage/memory-relevant resource type, which can be requested, allocated, and consumed. A storage/memory-relevant resource type may encompass a physical device, a logical intelligence, or a combination thereof, which may provide temporary or permanent data storage functionality and/or services. Examples of a storage/memory-relevant resource type may be (but not limited to): a hard disk drive (HDD), an SSD, RAM, Flash memory, a tape drive, an FC-based storage device, a floppy disk, a diskette, a compact disc (CD), a digital versatile disc (DVD), a NVMe device, a NVMe over Fabrics (NVMe-oF) device, resistive RAM (ReRAM), persistent memory (PMEM), virtualized storage, virtualized memory, etc.

As used herein, “storage” refers to a hardware component that is used to store data in a client. Storage may be a physical computer-readable medium. In most cases, storage may be configured as a storage array (e.g., a network attached storage array), in which a storage array may refer to a collection of one or more physical storage devices. Each physical storage device may include non-transitory computer-readable storage media, in which the data may be stored in whole or in part, and temporarily or permanently.

As used herein, “memory” may be any hardware component that is used to store data in a client. The data stored may be accessed almost instantly (e.g., in milliseconds) regardless of where the data is stored in memory. The memory may provide the above-mentioned instant data access because the memory may be directly connected to a CPU on a wide and fast bus (e.g., a high-speed internal connection that transfers data among hardware components of a client).

In one or more embodiments, a networking resource (not shown) may refer to a measurable quantity of a networking-relevant resource type, which can be requested, allocated, and consumed. A networking-relevant resource type may encompass a physical device, a logical intelligence, or a combination thereof, which may provide network connectivity functionality and/or services. Examples of a networking-relevant resource type may include (but not limited to): a network interface card, a network adapter, a network processor, etc. A networking resource may communicate via any suitable form of wired interface (e.g., Ethernet, fiber optic, serial communication etc.) and/or wireless interface, and may utilize one or more protocols (e.g., TCP, UDP, RDMA, IEEE 801.11, etc.) for the transmission and receipt of data.

In one or more embodiments, a virtualization resource (not shown) may refer to a measurable quantity of a virtualization-relevant resource type (e.g., a virtual hardware component), which can be requested, allocated, and consumed, as a replacement for a physical hardware component. A virtualization-relevant resource type may encompass a physical device, a logical intelligence, or a combination thereof, which may provide computing abstraction functionality and/or services. Examples of a virtualization-relevant resource type may include (but not limited to): a virtual server, a VM, a container, a virtual CPU, a virtual storage pool, etc.

As an example, a VM may be executed using computing resources of a data center. The VM (and applications hosted by the VM) may generate data (e.g., VM data) that is stored in the storage/memory resources of the data center, in which the VM data may reflect a state of the VM. In one or more embodiments, the VM may provide services to users, and may host instances of databases, email servers, or other applications that are accessible to the users.

In one or more embodiments, a virtualization resource may include a hypervisor, in which the hypervisor may be configured to orchestrate an operation of a VM by allocating computing resources of a data center to the VM. In one or more embodiments, the hypervisor may be a physical device including circuitry. The physical device may be, for example (but not limited to) a field-programmable gate array (FPGA), an application-specific integrated circuit, a programmable processor, a microcontroller, a digital signal processor, etc. The physical device may be adapted to provide the functionality of the hypervisor.

Alternatively, in one or more of embodiments, the hypervisor may be implemented as computer instructions, e.g., computer code, stored on storage/memory resources of the data center that when executed by processing resources of the client cause the data center to provide the functionality of the hypervisor.

In one or more embodiments, the power generation systems (e.g., 112, 122) may each include any number of power generation systems and combination of different types of power generation systems. The power generation systems (e.g., 112, 122) may include different power generating devices that produce varying amount of greenhouse gases during operation. For example, the power generation systems (e.g., 112, 122) may include wind power devices (e.g., offshore wind turbines, on shore wind turbines, etc.), hydroelectric devices, geothermal devices, solar power devices (e.g., solar panels, solar mirrors, etc.), natural gas devices (e.g., gas turbines, heat recovery steam generators, etc.), coal-based devices, nuclear devices (e.g., fission-based and/or fusion-based), oil-based devices, etc. As used herein, “sustainable energy” includes energy generated using wind power devices, hydroelectric devices, geothermal devices, solar power devices, nuclear devices, or other power generation devices that produce no greenhouse gases during the power generation step.

As noted above, each of the power generation systems (e.g., 112, 122) may include multiple, different power generating device the amount of sustainable energy provided to each data center may range from none of the energy provided to the respective data center to all of the energy provided to the respective data center and any percentage between all and none.

In one or more embodiments, the amount of power generated by sustainable energy methods and systems is dependent on the weather. For example, a sunny day would cause a solar device to generate more energy than a cloudy day. As such, the amount of sustainable energy provided by the power generation systems (e.g., 112, 122) may change over time. This change in sustainable energy may cause the respective data center to receive differing amounts of energy over time.

In one or more embodiments, the ratio of sustainable energy to non-sustainable provided by the power generation systems (e.g., 112, 122) changes over time. For example, the power generation systems (e.g., 112, 122) are configured to provide a consistent amount of energy to the respective data center and/or the amount of energy requested/demanded by the respective data center. In doing so, the power generation systems (e.g., 112, 122) may adjust the amount of energy generated using non-sustainable energy. For example, if the amount of sustainable energy produced by the power generation system is insufficient to meet the demand of the data center, the power generation system may increase the amount of non-sustainable energy produced to meet that demand.

In one or more embodiments, the client device may issue requests to the data centers (e.g., 110, 120, etc.) to receive responses and interact with various components of those data centers (e.g., 110, 120, etc.). Further, the client device may initiate an application to execute on the data centers (e.g., 110, 120, etc.) such that the application may (itself) gather, transmit, and/or otherwise manipulate data located in the data centers (e.g., 110, 120, etc.), remote to the client device. In one or more embodiments, the client device may share access to more than one data center and may similarly share any data located in those data centers.

In one or more embodiments, the client device may provide computer-implemented services to users (and/or other computing devices such as, other client device or other types of devices). The client device may provide any number and any type of computer-implemented services (e.g., data storage services, electronic communication services, etc.). To provide computer-implemented services, each client device may include a collection of physical components (e.g., processing resources, storage/memory resources, networking resources, etc.) configured to perform operations of the client and/or otherwise execute a collection of logical components (e.g., applications, virtualization resources, etc.) of the client device.

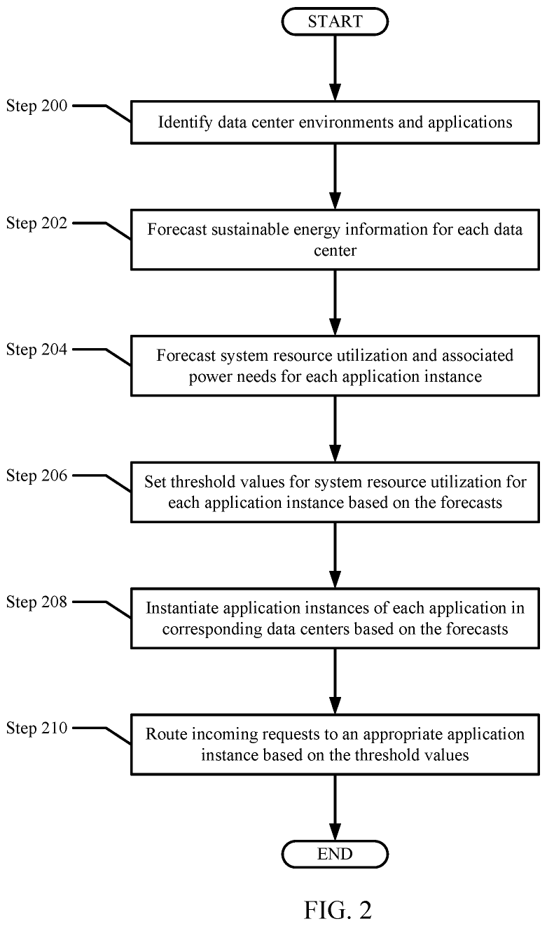

FIG. 2 shows a method for load balancing of application instances between data centers in accordance with one or more embodiments. While various steps in the method are presented and described sequentially, those skilled in the art will appreciate that some or all of the steps may be executed in different orders, may be combined or omitted, and some or all steps may be executed in parallel without departing from the scope of the invention.

The method shown in FIG. 2 may help to reduce the carbon footprint of an organization without affecting the data processing operations of the organization. For example, the method may provide for a method of predicting sustainable energy availability and future system resource utilization and associated power needs for data processing (e.g., through the use of applications and instances of applications). Further, the method may then maximize the use of the sustainable energy by routing requests first to the data center that utilizes a greater share of sustainable energy than other data centers. In doing so, an organization may maximize the use of sustainable energy available to that organization for data processing purposes (e.g., through the use of applications and instances of applications operating in data centers).

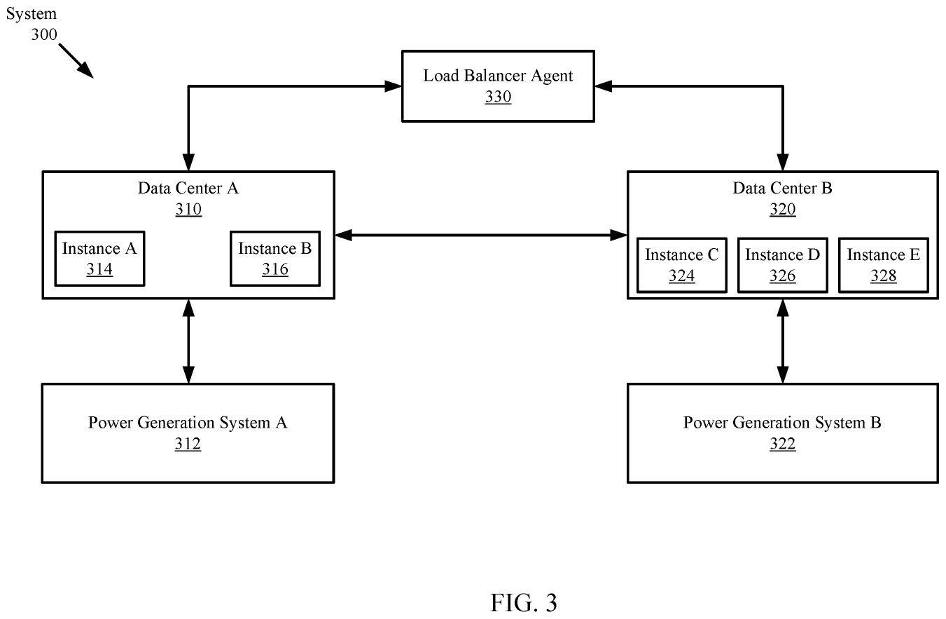

Turning now to FIG. 2, the method shown in FIG. 2 may be executed by, for example, the above-discussed load balancer agent (e.g., 130, FIG. 1). Other components of the system illustrated in FIG. 1 may also execute all or part of the method shown in FIG. 3 without departing from the scope.

In Step 200, the load balancer agent identifies data center (e.g., 110, 120, FIG. 1) environments and applications. Identifying the data center environment may include identifying (i) any portion, including all of, the hardware resources located in the data center and any details relating to the specifications of the hardware resources, including the type of the resource, quantity of the resource, power consumption of the resource, capabilities of the resource, etc., (ii) any portion, including all of, the connections between resources, (iii) the power connections from the power generation systems (e.g., 112, 122, FIG. 1) to the hardware resources, (iv) the physical location of the data centers, and (v) the location and type of the power generating systems. In one or more embodiments, any number of power generation systems, each with their own sustainable energy profiles, may each provide power to different portions of a respective data center. For example, a first power generation system with a first sustainable energy profile may provide power to a first portion of hardware resources in a data center, and a second power generation system with a second sustainable energy profile may provide power to a second portion of hardware resources, separate from the first portion, in the same data center. In one embodiment, power from multiple power generation systems may be combined into a single power connection, and the sustainable energy profile of the multiple power generation systems is combined into a single sustainable energy profile. Further, as used herein, “sustainable energy profile” means the percentage of power provided that is generated from sustainable energy sources.

Further, the load balancer agent identifies the application operating in the respective data center. In one or more embodiments, the load balancer agent collects, either directly or indirectly, usage data of the applications (including the hardware resources consumed by the applications), the power consumed by the applications, the timing of the consumption, etc.

In Step 202, the load balancer agent forecasts the sustainable energy information for each data center. As described above, the load balancer agent obtains and stores data indicative of the type and location of the power generating systems that provide power to each data center. Further, the load balancer agent obtains and stores data indicative of which portion of each data center utilizes the power provided by each power generating system. Further, as described above, the power generating systems may include systems whose power output is dependent on external factors, such as the weather.

In one or more embodiments, the load balancer agent is configured to receive weather data including predictions of weather for the locations of the data center and/or the power generating systems. The load balancer agent uses the weather data to then predict the amount of power that the power generating system will produce based, at least in part, on the predicted weather and/or historical data that relates the weather and power generated by the respective power generating system. The load balancer agent may be configured to predict a range of predicted power generated by the respective power generating systems. This range may include any suitable range and may be based on differences in historical data, confidence in weather predictions, the type of power generating system, or any other factor that may cause differences in the power generated by power generating systems. Further, the predictions may extend to any time in the future, as appropriate, including one hour, four hours, eight hours, twelve hours, one day, etc.

In one or more embodiments, the load balancer agent is configured to receive data from operators of the power generating systems regarding the predicted power generated by the power generation systems. For example, operators of power generating systems may generate their own predictions as to how much power the operators expect their power generating systems to predict at a given future time. The load balancer agent may then utilize the prediction provided by the operators as its own forecast. In one embodiment, the load balancer agent may perform its own forecast, receive a prediction from an operator of a power generating system, and combine the two into a single forecast. For example, the load balancer agent may apply the same or different weights to its own forecast and the prediction from the operator when combining the two into a single forecast.

In Step 204, the load balancer agent forecasts system resource utilization and associated power needs for each application instance. The load balancer agent obtains and stores data of historical system resource utilization and associated power needs for each application. For example, one application serves 100 requests per second and consumes a first amount of processing, memory, and power during regular business hours for a certain time zone and then decreases to 10 requests per second and consumes a second amount of processing, memory, and power outside of regular business hours for the certain time zone. In one or more embodiments, the forecast may be performed partially manually by a user entering a certain amount of system resources to be reserved and the load balancer agent may forecast the associated power needs for the amount of reserved system resources.

In Step 206, the load balancer agent sets threshold values for system resource utilization for each application instance based on the forecasts. The threshold values are the maximum values of resources that may be consumed in each data center and/or by each application instance. The threshold values may relate to any combination of memory consumption, processing consumption, requests per second, power consumption, network bandwidth, and any other resource consumed by an application instance. The threshold values may be based on either of the aforementioned forecasts. Further, the threshold values may also be based on the type of application instance and/or the respective data center environment. In one embodiment, the threshold values are also based on dependencies between application instances. For example, one or more application instances may be dependent on one or more other application instances operating at the same time. Thus, for a dependent application, the application load balancer bases the threshold values on the threshold values of the application from which the dependent application depends.

In Step 208, the load balancer agent instantiates application instances of each application in corresponding data centers based on the forecasts and/or the threshold values. For example, based on the forecasts and the threshold values, the load balancer agent instantiates two application instances on a first data center and three application instances on a second data center. Further, the load balancer agent also maximizes the amount of sustainable energy used to operate the application instances. As such, the load balancer agent may instantiate application instances on the data center with the highest ratio of sustainable energy first, then instantiate application instances on the data center with the second highest ratio of sustainable energy second, and so on until all of the application instances that are needed have been instantiated. Further, the load balancer agent may instantiate the maximum number of application instances on each data center, based on any combination of the forecasts, threshold values, and the data center environment before beginning to instantiate application instances on the next data center.

In Step 210, the incoming requests are routed to an appropriate application instance based on the threshold values and current utilization of the relevant application instance. This step may be performed by the load balancer agent or any other component that directs incoming requests. In one embodiment, the incoming requests are routed to the application instances that are consuming the highest ratio of sustainable energy first, and then the incoming requests are routed to the application instances that are consuming the second highest ratio of sustainable energy second, and so on. Further, the incoming requests may be routed to the application instances that are consuming the highest ratio of sustainable energy until those application instances cannot receive any more requests based on their threshold values. As such, the overall ration of sustainable energy used to handle the incoming requests is maximized across an organization's data centers, thereby reducing the carbon footprint of the organization.

Further, as the number of incoming requests increases and decreases over time, the number of resources needed to be consumed by each application also increases and decreases. As such, the load balancer agent auto scales each application instance accordingly. Further, the auto scaling may be performed according to certain constraints that may be set by a user, including threshold values (i.e., when a certain resource being consumed exceeds a certain percentage of the current maximum value, the resource values of the instance may be scaled up or when a certain resource being consumed falls below a certain percentage of the current maximum value, the resource values of the instance may be scaled down).

The method may end following Step 210.

### Example

FIG. 3 illustrates an example of the method of FIG. 2 to better understand the performance of the method. It should be understood that the example shown in FIG. 3 is merely a single example is not intended to limit the invention and is independent from any other examples discussed in this application. Turning to the example, consider a scenario in which multiple application instances are instantiated on different data centers.

Turning to the example, FIG. 3 shows a diagram of an example system. For the sake of brevity, not all components shown in FIG. 1 are illustrated in FIG. 3A. The example system (300) includes two data centers (310, 320), two corresponding power generation systems (312, 322), and a load balancer agent (330). For purposes of discussion, the two illustrated data centers (310, 320) include the same system resources as each other. As described above, the load balancer agent (330) forecasts the sustainable energy information for each data center (310, 320). In the present example, the power generation system A (312) produces a greater ratio of sustainable energy than the power generation system B (322). However, the load balancer agent (330) also forecasts that the power generation system A (312) will produce less power than the power generation system B (322). Further, the load balancer agent (330) forecasts the system resource utilization and associated power needs for each application instance and set the threshold values as described above. For example, the load balancer agent forecasts that 1000 requests will be received per second and each application instance can service 200 requests per second. As such, five application instances are required.

Then, based on the forecasts and/or the threshold values, the load balancer agent (330) instantiates the application instances (314, 316, 324, 326, 328). Based on the forecasts and/or the threshold values, the load balancer agent instantiates instance A (314) and instance B (316) on data center A (310), which is powered by a greater ratio of sustainable energy. However, based on the forecasts and/or the threshold values, the data center A (310) can only support a maximum of two application instances. Thus, the remaining application instances, instance C (324), instance D (326), and instance E (328) are instantiated on data center B (320). Thus, five instances, each capable of servicing 200 requests per second, are instantiated to service the forecasted 1000 requests per second.

Next, incoming requests from client devices are routed to the application instances (314, 316, 324, 326, 328). In the present example, the load balancer agent routes the incoming requests and first routes the incoming requests to instance A (314) or instance B (316) until each of instance A (314) and instance B (316) are servicing the maximum number of requests (i.e., 200 requests per second). For example, before routing an incoming request, the load balancer agent (330) determines that one of instance A (314) or instance B (316) has sufficient resources remaining to service an additional request. Then, the load balancer agent (330) routes the additional request to one of instance A (314) or instance B (316). Then, after instance A (314) or instance B (316) are each servicing 200 requests per second (i.e., the load balancer agent (330) determines that instance A (314) and instance B (316) are serving the maximum number of requests), the load balancer agent routes further incoming requests to the application instances in data center B (320) (i.e., instance C (324), instance D (326), and instance E (328)). As such, the load balancer agent (330) maximizes the use of the available sustainable energy while also enabling all of the incoming requests to be serviced, thereby reducing the carbon footprint without affecting the ongoing operations of the organization.

### End Example

Turning now to FIG. 4, FIG. 4 shows a diagram of a computing device in accordance with one or more embodiments of the invention.

In one or more embodiments of the invention, the computing device (400) may include one or more computer processors (402), non-persistent storage (404) (e.g., volatile memory, such as RAM, cache memory), persistent storage (406) (e.g., a hard disk, an optical drive such as a CD drive or a DVD drive, a Flash memory, etc.), a communication interface (412) (e.g., Bluetooth interface, infrared interface, network interface, optical interface, etc.), an input device(s) (410), an output device(s) (408), and numerous other elements (not shown) and functionalities. Each of these components is described below.

In one or more embodiments, the computer processor(s) (402) may be an integrated circuit for processing instructions. For example, the computer processor(s) (402) may be one or more cores or micro-cores of a processor. The computing device (400) may also include one or more input devices (410), such as a touchscreen, keyboard, mouse, microphone, touchpad, electronic pen, or any other type of input device. Further, the communication interface (412) may include an integrated circuit for connecting the computing device (400) to a network (e.g., a LAN, a WAN, Internet, mobile network, etc.) and/or to another device, such as another computing device.

In one or more embodiments, the computing device (400) may include one or more output devices (408), such as a screen (e.g., a liquid crystal display (LCD), plasma display, touchscreen, cathode ray tube (CRT) monitor, projector, or other display device), a printer, external storage, or any other output device. One or more of the output devices (408) may be the same or different from the input device(s) (410). The input and output device(s) (408, 410) may be locally or remotely connected to the computer processor(s) (402), non-persistent storage (404), and persistent storage (406). Many different types of computing devices exist, and the aforementioned input and output device(s) may take other forms.

The problems discussed throughout this application should be understood as being examples of problems solved by embodiments described herein, and the various embodiments should not be limited to solving the same/similar problems. The disclosed embodiments are broadly applicable to address a range of problems beyond those discussed herein.

While embodiments discussed herein have been described with respect to a limited number of embodiments, those skilled in the art, having the benefit of this Detailed Description, will appreciate that other embodiments can be devised which do not depart from the scope of embodiments as disclosed herein. Accordingly, the scope of embodiments described herein should be limited only by the attached claims.

What is claimed is:

1. A method for load balancing of application instances between a plurality data centers, the method comprising:
performing a first forecast of sustainable energy information for each of the plurality of data centers, wherein a first data center of the plurality of data centers is forecasted to be provided with a greater share of sustainable energy than a second data center of the plurality of data centers;
performing a second forecast of system resource utilization and associated power needs for an application;
instantiating, based on the first and second forecasts, a first plurality of application instances of the application in the first data center and a second plurality of application instances of the application in the second data center;
making a determination that one of the first plurality of application instances comprises sufficient resources to service an incoming request; and
routing, based on the determination, an incoming request to one of the first plurality of application instances.

2. The method of claim 1, further comprising:
making a second determination that all of the first plurality of application instances are servicing the maximum number of requests; and
routing, based on the second determination, a second incoming request to one of the second plurality of application instances.

3. The method of claim 2, further comprising:
setting, based on the first and second forecasts, a threshold value for each application instance.

4. The method of claim 3, wherein the determination and the second determination are based on the threshold value.

5. The method of claim 3, wherein the first plurality of application instances is the maximum number of application instances based on the first and second forecasts and the threshold value.

6. A method for load balancing of application instances between a plurality data centers, the method comprising:
performing a first forecast of sustainable energy information for each of the plurality of data centers, wherein a first data center of the plurality of data centers is forecasted to be provided with a greater share of sustainable energy than a second data center of the plurality of data centers;
performing a second forecast of system resource utilization and associated power needs for an application; and
instantiating, based on the first and second forecasts, a first plurality of application instances of the application in the first data center and a second plurality of application instances of the application in the second data center.

7. The method of claim 6, further comprising:
setting, based on the first and second forecasts, a threshold value for each application instance.

8. The method of claim 7, wherein the first plurality of application instances is the maximum number of application instances based on the first and second forecasts and the threshold value.

9. The method of claim 7, wherein the threshold value is based on one selected from the following:
memory consumption, processing consumption, requests per second, power consumption, and network bandwidth.

10. The method of claim 7, further comprising:
routing, based on the first and second forecasts and the threshold value, an incoming request to one of the first plurality of application instances or to one of the second plurality of application instances.

11. The method of claim 10, further comprising:
determining, before routing, that routing the incoming request would cause each of the first plurality of application instances to exceed a corresponding threshold value, and
wherein routing comprises routing the incoming request to one of the second plurality of application instances.

12. The method of claim 10, further comprising:
determining, before routing, that routing the incoming request would not cause at least one of the first plurality of application instances to exceed the corresponding threshold value, and
wherein routing comprises routing the incoming request to the at least one of the first plurality of application instances.

13. The method of claim 6, further comprising:
auto-scaling each application instance of the first and second plurality of application instances.

14. The method of claim 6, wherein the first forecast is based on predicted weather data.

15. The method of claim 6, wherein the second forecast is based on collected historical system resource utilization and associated power needs for the application.

16. A non-transitory computer readable medium comprising computer readable program code, which when executed by a computer processor enables the computer processor to perform a method for load balancing of application instances between a plurality data centers, the method comprising:
performing a first forecast of sustainable energy information for each of the plurality of data centers, wherein a first data center of the plurality of data centers is forecasted to be provided with a greater share of sustainable energy than a second data center of the plurality of data centers;
performing a second forecast of system resource utilization and associated power needs for an application;
setting, based on the first and second forecasts, a threshold value for each application instance; and
instantiating, based on the first and second forecasts and the threshold value, a first plurality of application instances of the application in the first data center and a second plurality of application instances of the application in the second data center.

17. The non-transitory computer readable medium of claim 16, wherein the first plurality of application instances is the maximum number of application instances based on the first and second forecasts and the threshold value.

18. The non-transitory computer readable medium of claim 16, wherein the threshold value is based on one selected from the following: memory consumption, processing consumption, requests per second, power consumption, and network bandwidth.

19. The non-transitory computer readable medium of claim 16, wherein the method further comprises:
routing, based on the first and second forecasts and the threshold value, an incoming request to one of the first plurality of application instances or to one of the second plurality of application instances.

20. The non-transitory computer readable medium of claim 19, wherein the method further comprises:
determining, before routing, that routing the incoming request would cause each of the first plurality of application instances to exceed a corresponding threshold value, and
wherein routing comprises routing the incoming request to one of the second plurality of application instances.
